(19) United States
(12) Patent Application Publication
(10) Pub. No.: US 2007/0230316 A1
(43) Pub. Date: Oct. 4, 2007

(54) Information Recording Medium, Information Reproducing Apparatus and Method, Information Recording Apparatus and Method, and Computer Program

(76) Inventor: Yoshimi Tomita, Saitama (JP)

Correspondence Address: YOUNG & THOMPSON, 745 SOUTH 23RD STREET, 2ND FLOOR, ARLINGTON, VA, 22202, US

(21) Appl. No.: 10/594,838

(22) PCT Filed: Mar. 29, 2005
(86) PCT No.: PCT/JP05/05873

§ 371 Date: Nov. 28, 2006

(30) Foreign Application Priority Data
Mar. 29, 2004 (JP) 2004-096520

(51) Int. Cl. G11B 7/00

(52) U.S. Cl. 369/124.07

(57) ABSTRACT

An information recording medium (100) is an information recording medium wherein recording information is recorded by forming a recording mark. Additional information is recorded by comparing an average area of the recording mark of every prescribed first cycle with a prescribed reference value and changing the average area

### TECHNICAL FIELD

The present invention relates to an information recording medium, such as a DVD, an information reproducing apparatus, such as a DVD player, an information reproducing method, an information recording apparatus, such as a DVD recorder, an information recording method, and a computer program which makes a computer function as the information reproducing apparatus or the information recording apparatus, for example.

### BACKGROUND ART

With regard to an information recording medium such as an optical disc, various data including content data or the like is recorded, by forming record marks (e.g. recording pits or the like) on a recording surface. Specifically, by combining record marks with predetermined lengths or the like as occasion demands, video data, audio data, data for PC or the like, for example, are recorded. As such an information recording medium, for example, a DVD, a CD or the like can be listed, as its one specific example.
Patent document 1: Japanese Patent Application Laid Open No. 2003-91822
Patent document 2: Japanese Patent Application Laid Open No. 2002-157734

### DISCLOSURE OF INVENTION

Subject to be Solved by the Invention

With regard to such an optical disc, various additional information is recorded, as well as the content data to be originally recorded. For example, in the case of a DVD-R/RW as one specific example of the information recording medium, various data other than the content data is recorded by using a land pre-pit formed on a recording track (specifically, a land track).

It is therefore an object of the present invention to provide an information recording medium, an information reproducing apparatus, an information reproducing method, an information recording apparatus, and an information recording method, capable of properly recording additional information in addition to record information including the content data or the like, without using a conventional method, and capable of properly reproducing the recorded additional information, and a computer program which makes a computer function as such an information reproducing apparatus or such an information recording apparatus.

Means for Solving the Subject

(Information Recording Medium)

The above object of the present invention can be achieved by an information recording medium on which record information is recorded by forming a record mark, wherein additional information is recorded by changing an average area (average dimensions) of the record mark included in each predetermined first cycle, in comparison with a predetermined reference value.

According to the information recording medium of the present invention, the record information is recorded onto the information recording medium, by forming the record mark (e.g. a recording pit in an information recording medium of a DVD-ROM or the like, and a record mark in an information recording medium of a DVD-R/RW or the like).

Particularly in the present invention, the record mark is formed, by changing the average area of the record mark included (or appearing) in each predetermined cycle, in comparison with the predetermined reference value. Specifically, the record mark is formed such that the average area in a certain cycle (or in a certain recording area) is larger than the reference value. On the other hand, the record mark is formed such that the average area in a certain cycle is smaller than the reference value. On the basis of a difference of the average area of the record mark, the additional information, such as “0” and “1”, for example, is assigned. For example, if the average area of the record mark is larger than the reference value, the additional information of “1” may be recorded. On the other hand, if the average area of the record mark is smaller than the reference value, the additional information of “0” may be recorded. As described above, it is possible to record the additional information which is information further added, by including the additional information in the record mark formed to record the record information. Of course, it is preferable to change the average area of the record mark, to the extent that the changing of the average area of the record mark does not influence the recording of the normal record information.

Consequently, according to the information recording medium of the present invention, it is possible to record the additional information in addition to the normal record information. Then, in addition to the reproduction of the record information performed by an information reproducing apparatus described later, the additional information can be properly reproduced. Moreover, in addition to the recording of the record information performed by an information recording apparatus described later, the additional information can be properly recorded.

Incidentally, it is not limited to changing the average area of the record mark by increasing or reducing it in comparison with the predetermined reference value. It may be also constructed such that the average area of a certain record mark is set as the reference value, for example, and the average area of another record mark is changed by increasing or reducing it in comparison with the set reference value.

In one aspect of the information recording medium of the present invention, the record information is recorded in synchronization with a synchronization signal which appears in each predetermined second cycle, and the additional information is recorded, by using the second cycle of the synchronization signal as the first cycle.

According to this aspect, it is possible to record the additional information, by changing the average area of the record mark, as occasion demands, on the basis of the synchronization signal which is a reference in recording the record information. Therefore, as in the case where the record information is recorded or reproduced, it is possible to properly record or reproduce the additional information (i.e. it is possible to properly record or reproduce the additional information while the synchronization signal is referred to, for example).

In an aspect of the information recording medium in which the record information is recorded in synchronization with the synchronization signal, as described above, the additional information may be recorded, by using a cycle of a timing signal which is generated on the basis of the synchronization signal as the first cycle, instead of using the second cycle as the first cycle.

By virtue of such construction, the additional information can be recorded, by changing the average area of the record mark, as occasion demands, on the basis of not only the synchronization signal but also the cycle of the timing signal (e.g. a cycle twice or half as much as that of the synchronization signal, or the like) generated on the basis of the synchronization signal. Therefore, it is possible to change the recording density of the additional information, as occasion demands, if needed.

In an aspect of the information recording medium in which the record information is recorded in synchronization with the synchronization signal, as described above, the synchronization signal may be a synchronization block which is included in a synchronization frame which is an information unit for recording the record information.

By virtue of such construction, it is possible to properly record the additional information in accordance with a format in conformity with which the record information is recorded.

In another aspect of the information recording medium of the present invention, the additional information is phase-modulated and recorded.

According to this aspect, the phase modulation, such as BPM (Bi Phase Modulation), for example, is performed with respect to the additional information, and the additional information is then recorded. By this, it is possible to eliminate an influence on the additional information, which is caused by the normal record information, as described later in detail.

In another aspect of the information recording medium of the present invention, at least one portion of the information recording medium is provided with a PEP area in which PEP information is recorded by combining a mark area in which a plurality of record marks are formed and an unrecorded area in which the record mark is not formed, and the additional information is recorded by changing the average area of the plurality of record marks in the mark area.

According to this aspect, the above-mentioned additional information can be recorded, also by changing the average area of the record marks formed in the mark area of the information recording medium having the PEP area.

Incidentally, it may be constructed such that the average area of the record marks in each mark area is changed, or that the average area of the record marks is changed in a predetermined unit (i.e. in each cycle) in the mark area.

In another aspect of the information recording medium of the present invention, the additional information is recorded by changing at least one of an average length and an average width of the record mark in the each predetermined first cycle.

According to this aspect, it is possible to change the average area of the record mark, relatively easily, and as a result, it is possible to record the additional information, relatively easily.

In an aspect of the information recording medium in which at least one of the average length and the average width of the record mark is changed, as described above, the additional information may be recorded by changing at least one of the average length and the average width such that at least one of the average length and the average width becomes long or short.

By virtue of such construction, it is possible to properly record the additional information, by increasing the average length or the average width of the record mark, as occasion demands (i.e. by increasing the average area) or reducing it (i.e. by reducing the average area), in comparison with the predetermined value.

In another aspect of the information recording medium of the present invention, a plurality of same additional information are repeatedly recorded.

According to this aspect, it is possible to improve the reliability of the additional information to be recorded.

Information Reproducing Apparatus)

The above object of the present invention can be also achieved by an information reproducing apparatus for reproducing the record information recorded on the above-mentioned information recording medium of the present invention (including its various aspects), the information reproducing apparatus provided with: a reproducing device for reproducing the record information and obtaining a reproduction signal; an integrating device for obtaining an integrated value of the reproduction signal in the each first cycle obtained by the reproducing device; and a generating device for generating the additional information on the basis of the integrated value obtained by the integrating device.

According to the information reproducing apparatus of the present invention, the record information is reproduced by the operation of the reproducing device, and thus, the reproduction signal (e.g. a RF signal described later) is obtained. Then, on the basis of the reproduction signal, it is possible to reproduce the record information including the normal content data or the like.

In the meanwhile, by the operation of the integrating device, the reproduction signal is integrated in each predetermined first cycle. At this time, since the average area of the record mark formed on the information recording medium in each predetermined first cycle is changed, the integrated value of the reproduction signal is changed due to the difference in the average area. For example, the reproduction signal of the record mark whose average area is larger than the reference value has a relatively small integrated value (or smaller than a certain value), as described later. On the other hand, the reproduction signal of the record mark whose average area is smaller than the reference value has a relatively large integrated value (or larger than a certain value), as described later.

Therefore, on the basis of the change (e.g. large or small) in the integrated value, it is possible to generate (obtain) the additional information by the operation of the generating device. For example, if the integrated value is relatively small, the additional information “1” may be generated, for example. If the integrated value is relatively large, the additional information “0” may be generated, for example.

Consequently, according to the information reproducing apparatus of the present invention, it is possible to properly reproduce the record information recorded on the above-mentioned information recording medium of the present invention, and it is also possible to properly reproduce the additional information.

Incidentally, in response to the above-mentioned various aspects of the information recording medium of the present invention, the information reproducing apparatus of the present invention can also adopt various aspects.

In one aspect of the information reproducing apparatus of the present invention, the record information is recorded in synchronization with a synchronization signal which appears in each predetermined second cycle, the information reproducing apparatus is further provided with a synchronization signal detecting device for detecting the synchronization signal, and the integrating device obtains the integrated value, by using the second cycle of the synchronization signal detected by the synchronization signal detecting device as the first cycle.

According to this aspect, it is possible to properly reproduce the additional information, from the record mark whose average area is changed on the basis of the synchronization signal which is a reference in recording the record information.

In an aspect of the information reproducing apparatus provided with the for detecting the synchronization, as described above, the integrating device may obtain the integrated value, by using a cycle of a timing signal which is generated on the basis of the synchronization signal detected by the synchronization signal detecting device as the first cycle, instead of using the second cycle as the first cycle.

By virtue of such construction, it is possible to properly reproduce the additional information, from the record mark whose average area is changed on the basis of not only the synchronization signal but also the cycle of the timing signal which is generated on the basis of the synchronization signal.

In another aspect of the information reproducing apparatus of the present invention, the integrating device resets the integrated value in the each first cycle.

According to this aspect, it is possible to properly obtain the integrated value of the reproduction signal in association with the predetermined first cycle, and as a result, it is possible to properly reproduce the additional information.

In another aspect of the information reproducing apparatus of the present invention, at least one portion of the information recording medium is provided with a PEP area in which PEP information is recorded by combining a mark area in which a plurality of record marks are formed and an unrecorded area in which the record mark is not formed, and the additional information is recorded by changing the average area of the plurality of record marks in the mark area, in comparison with the reference value, the reproducing device obtains a PEP signal by reproducing the PEP information in the PEP area, and the integrating device obtains an integrated value of the PEP signal by using a cycle in each which the PEP information is detected, as the first cycle, instead of or in addition to obtaining the integrated value of the reproduction signal in the each first cycle.

According to this aspect, even if the PEP information with the additional information added thereto is recorded on the information recording medium provided with the PEP area, it is possible to properly generate the additional information. Incidentally, the PEP signal may be integrated, by using the cycle of the timing signal which is generated on the basis of a cycle in each which the PEP information is detected as the first cycle, instead of using a cycle in each which the PEP information is detected as the first cycle.

In another aspect of the information reproducing apparatus of the present invention, a plurality of same additional information are repeatedly recorded on the information recording medium, the information reproducing apparatus is further provided with a plurality of storing devices, each of which is for adding the integrated value obtained by the integrating device in each of the plurality of same additional information repeatedly recorded and for storing it therein, and the generating device generates the additional information on the basis of the added integrated value.

According to this aspect, even if the plurality of additional information is repeatedly recorded, it is possible to properly reproduce the additional information. Namely, by separately storing the integrated value into the storing device, in each of the plurality of same additional information repeatedly recorded, it is possible to properly generate target identification information without mixing it with other additional information.

In an aspect of the information reproducing apparatus provided with the plurality of storing devices, as described above, the integrating device may reset the added integrated value, in at least one case of a case where the integrated value stored in each of the plurality of storing devices is larger than a predetermined threshold value and a case where a certain time elapses.

By virtue of such construction, even if the plurality of additional information is repeatedly recorded, it is possible to properly reset the integrated value, and it is possible to properly reproduce the additional information.

(Information Reproducing Method)

The above object of the present invention can be also achieved by an information reproducing method of reproducing the record information recorded on the above-mentioned information recording medium of the present invention (including its various aspects), the information reproducing method provided with: a reproducing process of reproducing the record information and obtaining a reproduction signal; an integrating process of obtaining an integrated value of the reproduction signal in the each first cycle obtained by the reproducing process; and a generating process of generating the additional information on the basis of the integrated value obtained by the integrating process.

According to the information reproducing method, it is possible to receive the same various aspects as those of the above-mentioned information reproducing apparatus of the present invention.

Incidentally, in response to the above-mentioned various aspects of the information recording medium of the present invention, the information reproducing method of the present invention can also adopt various aspects.

(Information Recording Apparatus)

The above object of the present invention can be also achieved by an information recording apparatus for recording record information onto an information recording medium, the information recording apparatus provided with: a recording signal generating device for generating a recording signal for forming a record mark onto the information recording medium, on the basis of the record information; an additional signal adding device for adding an additional signal to the recording signal, the additional signal indicating additional information which is recorded by changing an average area of the record mark in each predetermined first cycle, in comparison with a predetermined reference value; and a recording device for recording the record information and the additional information by forming the record mark while changing the average area, on the basis of the recording signal to which the additional signal is added.

According to the information recording apparatus of the present invention, by the operation of the recording signal generating device, the recording signal for recording the record information, such as content data, is generated. In the meanwhile, by the operation of the additional signal adding device, the additional signal indicating the additional information is added to the recording signal generated by the recording signal generating device. The additional signal is a signal used to record the additional information, and as described above, the additional signal is generated so as to change (e.g. increase or reduce) the average area of the record mark in each predetermined first cycle. For example, if the additional information of “0” is recorded, the additional signal is generated so as to increase the average area of the record area. On the other hand, if the additional information of “1” is recorded, the additional signal is generated so as to reduce the average area of the record area. Then, on the basis of the recording signal to which the additional signal is added, the record mark is formed onto the information recording medium, by the operation of the recording device. Namely, by forming the record mark so as to change the average area of the record mark in each predetermined first cycle, the record information which is based on the recording signal and the additional information which is based on the additional signal are recorded.

Consequently, according to the information recording apparatus of the present invention, it is possible to form the record mark so as to change the average area of the record mark, in comparison with the predetermined reference value, and as a result, it is possible to further record the additional information, in addition to the record information.

Incidentally, in response to the above-mentioned various aspects of the information recording medium of the present invention, the information recording apparatus of the present invention can also adopt various aspects.

In one aspect of the information recording apparatus of the present invention, it is further provided with a synchronization signal generating device for generating a synchronization signal which appears in each predetermined second cycle, the recording signal generating device generates the recording signal for forming the record mark in synchronization with the generated synchronization signal, and the additional signal adding device adds the additional signal by using the second cycle as the first cycle.

According to this aspect, it is possible to record the additional information by changing the average area of the record mark, as occasion demands, on the basis of the synchronization signal which is a reference in recording the record information. Therefore, as in the case where the record information is recorded, the additional information can be properly recorded.

In an aspect of the information recording apparatus provided with the synchronization signal generating device, as described above, the additional signal adding device may add the additional signal, by using a cycle of a timing signal which is generated on the basis of the synchronization signal as the first cycle.

By virtue of such construction, it is possible to record the additional information by changing the average area of the record mark, as occasion demands, on the basis of not only the synchronization signal but also the cycle of the timing signal which is generated on the basis of the synchronization signal. Therefore, it is possible to change the recording density of the additional information, as occasion demands, if needed.

In another aspect of the information recording apparatus of the present invention, the recording device forms the record mark by irradiating laser light on the basis of a predetermined driving pulse, and irradiates the laser light while changing at least a pulse width of the driving pulse, on the basis of the recording signal to which the additional signal is added.

In this aspect, it is possible to change the average area and form the record mark, relatively easily, by changing the shape of the driving pulse (particularly, the pulse width along the time axis direction). Therefore, it is possible to record the additional information, relatively easily.

(Information Recording Method)

The above object of the present invention can be also achieved by an information recording method of recording record information onto an information recording medium, the information recording method provided with: a recording signal generating process of generating a recording signal for forming a record mark onto the information recording medium, on the basis of the record information; an additional signal adding process of adding an additional signal to the recording signal, the additional signal indicating additional information which is recorded by changing an average area of the record mark in each predetermined first cycle, in comparison with a predetermined reference value; and a recording process of recording the record information and the additional information by forming the record mark while changing the average area, on the basis of the recording signal to which the additional signal is added.

According to the information recording method, it is possible to receive the same various aspects as those of the above-mentioned information recording apparatus of the present invention.

Incidentally, in response to the above-mentioned various aspects of the information recording medium of the present invention, the information recording method of the present invention can also adopt various aspects.

(Computer Program)

The above object of the present invention can be also achieved by a first computer program for reproduction control to control a computer provided in the above-mentioned information reproducing apparatus of the present invention (including its various aspects), the computer program making the computer function as at least one portion of the reproducing device, the integrating device, and the generating device.

According to the first computer program of the present invention, the above-mentioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the information reproducing apparatus of the present invention, the first computer program of the present invention can also adopt various aspects.

The above object of the present invention can be also achieved by a second computer program for recording control to control a computer provided in the information recording apparatus according to claim 18, the computer program making the computer function as at least one portion of the recording signal generating device, the additional signal adding device, and the recording device.

According to the second computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the information recording apparatus of the present invention, the first computer program of the present invention can also adopt various aspects.

The above object of the present invention can be also achieved by a first computer program product in a computer-readable medium for tangibly embodying a program of instructions executable by a computer provided in the information reproducing apparatus of the present invention (including its various aspects), the computer program product making the computer function as at least one portion of the reproducing device, the integrating device, and the generating device.

According to the first computer program product of the present invention, at least one portion of the reproducing device, the integrating device, and the generating device of the present invention described above can be embodied relatively readily, by loading the computer program product from a recording medium for storing the computer program product, such as a ROM Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the reproducing device, the integrating device, and the generating device.

The above object of the present invention can be also achieved by a second computer program product in a computer readable medium for tangibly embodying a program of instructions executable by a computer provided in the information recording apparatus of the present invention (including its various aspects), the computer program product making the computer function as at least one portion of the recording signal generating device, the additional signal adding device, and the recording device.

According to the second computer program product of the present invention, at least one portion of the recording signal generating device, the additional signal adding device, and the recording device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the recording signal generating device, the additional signal adding device, and the recording device.

These effects and other advantages of the present invention will become more apparent from the following embodiments.

As explained above, on the information recording medium of the present invention, the record mark is formed while the average area of the record mark in each first cycle is changed. Therefore, it is possible to properly record the additional information which is additional record information, in addition to the record information including normal content data or the like.

Moreover, the information reproducing apparatus of the present invention is provided with: the reproducing device; the integrating device; and the generating device, the information reproducing method of the present invention is provided with: the reproducing process; the integrating process; and the generating process. Therefore, it is possible to properly reproduce the record information recorded on the information recording medium of the present invention, and it is also possible to obtain the additional information.

Moreover, the information recording apparatus of the present invention is provided with: the recording signal generating device; the additional signal adding device; and the recording device, the information recording method of the present invention is provided with: the recording signal generating process; the additional signal adding process; and the recording process. Therefore, it is possible to properly record the record information onto the information recording medium of the present invention, and it is also possible to record the additional information.

### BRIEF DESCRIPTION OF DRAWINGS

FIG. 1 is a substantial plan view showing the basic structure of an optical disc as one example of a first embodiment of the information recording medium of the present invention, the optical disc having a plurality of recording areas, in the upper part, in association with a schematic conceptual view showing record marks recorded onto the optical disc in the lower part.

FIG. 2 is a plan view conceptually showing a more detailed structure of the record marks recorded onto the information recording medium in the first embodiment.

FIG. 3 are graphs conceptually showing a reproduction signal in reproducing the record marks recorded onto the information recording medium in the first embodiment.

FIG. 4 is an explanatory diagram conceptually showing one aspect of the recording of additional information recorded onto the information recording medium in the first embodiment.

FIG. 5 is a data structure diagram conceptually showing another aspect of the recording of additional information recorded onto the information recording medium in the first embodiment.

FIG. 6 is a data structure diagram conceptually showing another aspect of the recording of additional information recorded onto the information recording medium in the first embodiment.

FIG. 7 is a data structure diagram conceptually showing another aspect of the recording of additional information recorded onto the information recording medium in the first embodiment.

FIG. 8 is a data structure diagram conceptually showing another aspect of the recording of additional information recorded onto the information recording medium in the first embodiment.

FIG. 9 is a data structure diagram conceptually showing another aspect of the recording of additional information recorded onto the information recording medium in the first embodiment.

FIG. 10 is a substantial plan view showing the basic structure of an optical disc as one example of a second embodiment of the information recording medium of the present invention, the optical disc having a plurality of recording areas, in the upper part, in association with a schematic conceptual view showing record marks recorded in a PEP area of the optical disc in the lower part.

FIG. 11 is a data structure diagram conceptually showing one aspect of the recording of additional information recorded onto the information recording medium in the second embodiment.

FIG. 12 is a data structure diagram conceptually showing another aspect of the recording of additional information recorded onto the information recording medium in the second embodiment.

FIG. 13 is a block diagram conceptually showing the basic structure of a first embodiment of the information reproducing apparatus of the present invention.

FIG. 14 is a flowchart conceptually showing a flow of the entire data reproduction operation of the information reproducing apparatus in the first embodiment.

FIG. 15 is a block diagram conceptually showing the basic structure of a second embodiment of the information reproducing apparatus of the present invention.

FIG. 16 is a flowchart conceptually showing a flow of the entire data reproduction operation of the information reproducing apparatus in the second embodiment.

FIG. 17 is a block diagram conceptually showing the basic structure of a third embodiment of the information reproducing apparatus of the present invention.

FIG. 18 is a block diagram conceptually showing the basic structure of an embodiment of the information recording apparatus of the present invention.

FIG. 19 are explanatory diagrams conceptually showing the shape of a driving pulse for irradiating laser light used in the recording operation of the information recording apparatus in the embodiment.

FIG. 20 is an explanatory diagram conceptually showing an aspect of transition of the shape of the driving pulse used in the recording operation of the information recording apparatus in the embodiment.

### DESCRIPTION OF REFERENCE CODES

1, 2, 3 information reproducing apparatus
4 information recording apparatus
100, 101 optical disc
301 optical pickup
303 RF amplifier
306 synchronization signal detector
307 timing signal generator
308 integrator
309 CPU
310 memory
311, 312, 313, 314 memory
320 PEP signal detector
401 optical pickup
403 strategy circuit
404 comparator
405 LPF
406 additional information recording signal generator
407 timing signal generator
408 CPU
409 memory

### BEST MODE FOR CARRYING OUT THE INVENTION

Hereinafter, the best mode for carrying out the present invention will be explained in each embodiment in order, with reference to the drawings.

### Embodiments of Information Recording Medium

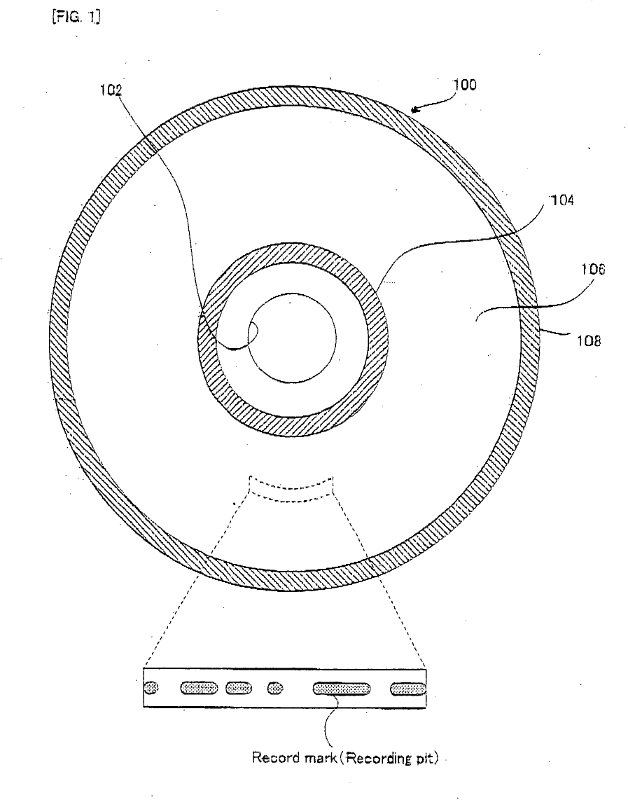

Firstly, optical discs as embodiments of the information recording medium of the present invention will be explained, with reference to FIG. 1 to FIG. 12.

### (1) First Embodiment

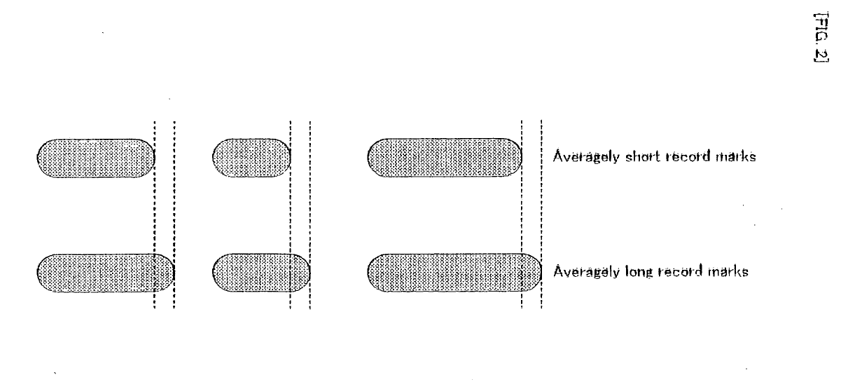

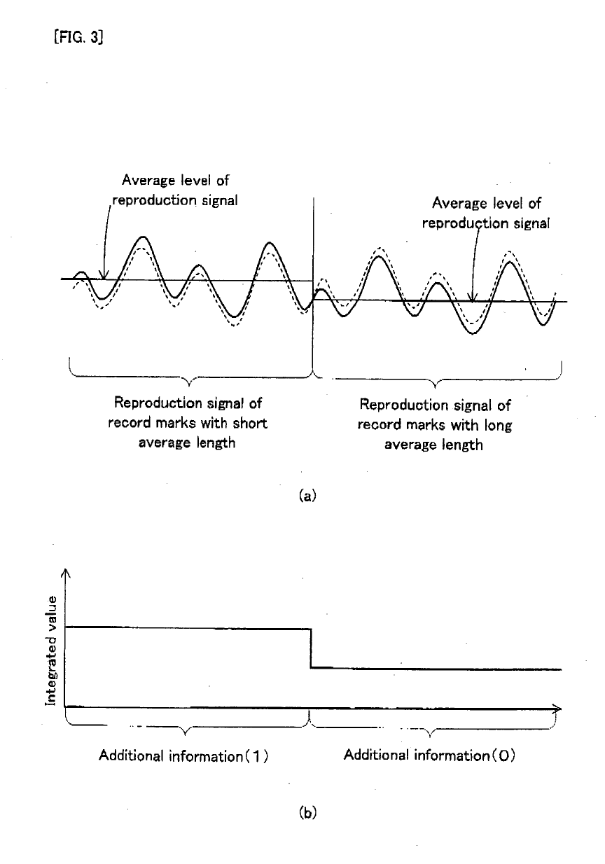

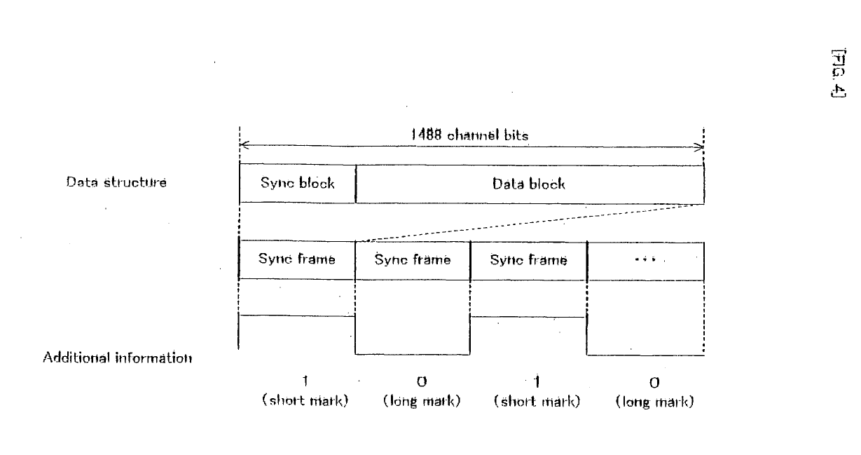

Firstly, with reference to FIG. 1 to FIG. 4, the basic structure of an optical disc 100 as a first embodiment of the information recording medium of the present invention will be explained. FIG. 1 shows the structure of the optical disc 100 having a plurality of recording areas in a substantial plan view in the upper part, and shows record marks recorded onto the optical disc 100 in a schematic conceptual view in the lower part. FIG. 2 is a plan view conceptually showing a more detailed structure of the record marks recorded onto the optical disc 100. FIG. 3 are graphs conceptually showing a reproduction signal in reproducing the record marks recorded onto the optical disc 100. FIG. 4 is an explanatory diagram conceptually showing one aspect of the recording of additional information recorded onto the optical disc 100.

As shown in FIG. 1, the optical disc 100 has a recording surface on a disc main body with a diameter of about 12 cm, as is a DVD. On the recording surface, the optical disc 100 is provided with: a center hole 102 as the center; a lead-in area 104; a data recording area 106; and a lead-out area 108, from the inner circumference to the outer circumference. In each area, a groove track and a land track may be alternately placed, spirally or concentrically, centered on the center hole 102, for example. The groove track may be wobbled, and pre-its may be formed on one or both of the tracks. Incidentally, the present invention is not particularly limited to the optical disc having these three areas. For example, even if the lead-in area 104 or the lead-out area 108 does not exist, a file structure explained later can be constructed. Moreover, as described later, the lead-in area 104 or the lead-out area 108 may be further segmentized.

On the optical disc 100 in the first embodiment, various content data (or other management data, or the like) is recorded by arbitrarily changing the average length of each record mark, as shown in FIG. 2. For example, as shown in the upper part of FIG. 2, record marks (or recording pits) with a relatively short average length are formed, or as shown in the lower part of FIG. 2, record marks with a relatively long average length are formed. Namely, normally, the all of record marks each of which indicates the same data are formed with the same length; however, in the embodiment, the length of the record marks is set to relatively long or relatively short For example, the record marks relatively longer or shorter than a certain reference length may be formed. Alternatively, on the basis of the length of one of the record marks, the record marks relatively longer or shorter may be formed. If two types of record marks with different average lengths are formed, it is possible to record additional information, as described later. Of course, in the case where the average length of the record marks is long or short, it is preferable to change the length well enough to avoid such a disadvantage that the content data cannot be properly reproduced due to the change in length. Then, the average length of the record marks becomes long or short in each predetermined cycle.

Incidentally, the recording of the additional information can be adapted to all the information recording media on which the data is recorded by forming the record marks (or recording pits or the like). Specifically it can be adapted to a DVD, a CD (Compact Disc), a MO (Magneto Optical Disc), a MD (Mini Disc), a Blu-ray Disc, a HDDVD (High Definition DVD), an EVD (Enhanced Versatile Disc), or the like, for example. The record marks may be formed by a change due to heat as in the DVD-R/RW or the like, for example. The recording marks may be formed as a physical shape as in the DVD-ROM or the like, for example. The recording marks may be formed by a change due to irradiation of light. The recording marks may be formed by other methods.

Then, by assigning additional information of “0” to the record marks with the short average length, and additional information of “1” to the record marks with the long average length, it is, possible to farther record the predetermined additional information, in addition to the normal content data. As the additional information, various information, such as information for copy protection and other information required for data recording or data reproduction, can be recorded, for example.

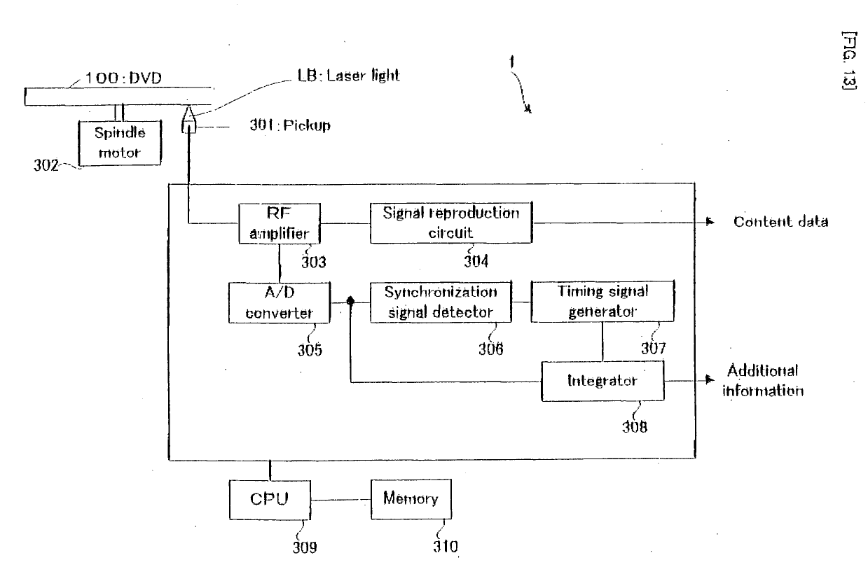

If the record marks formed with the different average lengths are reproduced by an information reproducing apparatus described later (refer to FIG. 13 etc.), it is possible to obtain a reproduction signal (e.g. a RF signal or the like) shown in FIG. 3(a). As shown in FIG. 3(a), if a portion of record marks with the long average length is reproduced, the average level of the reproduction signal becomes relatively low. On the other hand, if a portion of the record marks with the short average length is reproduced, the average level of the reproduction signal becomes relatively high. Incidentally, in FIG. 3(a), a curve shown in a dashed line shows a reproduction signal indicating an average of the reproduction signal related to the record mark portion with the long average length and the reproduction signal related to the record mark portion with the short average length.

Then, the record marks formed on the optical disc, such as the DVD, for example, are formed such that the DC component included in the reproduction signal in reproducing the record marks is “0”. Therefore, if the reproduction signal shown in FIG. 3(a) is integrated by an integrator described later (refer to FIG. 13, etc.), for example, it is possible to obtain information which indicates that the integrated value is high or low, as shown in FIG. 3(b). Namely, the integrated value of the reproduction signal in reproducing the record marks with the short average length is relatively high. On the other hand, the integrated value of the reproduction signal in reproducing the record marks with the long average length is relatively low. By this, it is possible to identify or differentiate “0” or “1” of the additional information described above. Then, by combining this “0” or “1”, it is possible to record the various additional information.

Incidentally, in the first embodiment, the additional information is recorded by increasing or reducing the average length of the record marks. However, the additional information may be recorded by thickening or thinning the average width (i.e. the length in the radial direction of the record marks) of the record marks, while equalizing the average length (i.e. the length in the disc rotational direction of the record marks). Alternatively, the additional information may be recorded by increasing or reducing the average area of the record marks. In any case, since the reproduction signal varies depending on a difference in the average width (or average area) of the record marks, as shown in FIG. 3, it is possible to properly record or reproduce the additional information.

According to the optical disc 100 in the first embodiment, as shown in FIG. 4, 1-bit additional information is recorded in each sync frame (i.e. one specific example of the “synchronization frame” of the present invention) which can be a basic unit in recording the data onto the optical disc, such as a the DVD, for example. Namely, the average length of the record marks which are formed in order to record the data corresponding to the data amount of one sync frame is increased or reduced. For example, FIG. 4 shows four sync frames, and the content data or the like is recorded by using the record marks with the relatively short average length, in the first and third sync frames. Therefore, the additional information indicating “0” is further recorded in the two sync frames. On the other hand, the content data or the like is recorded by using the record marks with the relatively long average length, in the second and fourth sync frames. Therefore, the additional information indicating “1” is further recorded in the two sync frames.

Moreover, each sync frame has a data amount of 1488 channel bits, as shown in the upper part of FIG. 4. Each sync frame has a sync block (i.e. one specific example of the “synchronization block” of the present invention) for obtaining a synchronization signal in the data recording or data reproduction and a data block in which the actual content data or the like is recorded. In other words, on the optical disc 100 shown in FIG. 4, the additional information is recorded while synchronized with the sync block of the sync frame. Then, the integration of the reproduction signal by the integrator described above is performed by this sync frame unit.

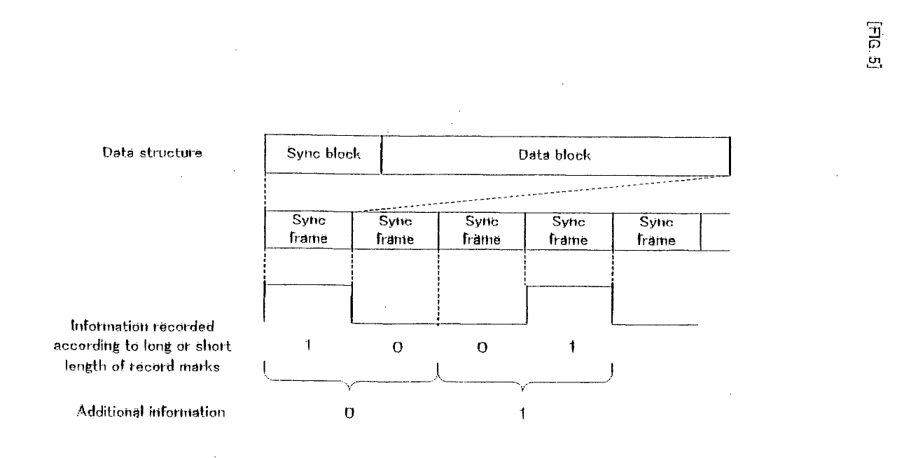

The method of recording the additional information, however, is not limited to such an aspect that the 1-bit additional information is recorded in each one sync frame as shown in FIG. 4. The recording can be performed in various aspects. Namely, instead of or in addition to recording the additional information in each sync frame cycle as one specific example of the “second cycle” of the present invention, the additional information may be recorded in each cycle determined on the basis of the sync frame as one specific example of the “cycle of the timing signal” of the present invention. Hereinafter, the aspects of the recording of the additional information will be explained in more detail, with reference to FIG. 5 to FIG. 9. FIG. 5 to FIG. 9 are data structure diagrams conceptually showing other aspects of the recording of the additional information in the first embodiment.

As shown in FIG. 5, the additional information may be recorded by performing phase encoding or BPM (Bi Phase Modulation) modulation thereto. For example, “On as the additional information is recorded actually as “10” onto the optical disc 100, whereas “1” as the additional information is recorded actually as “01” onto the optical disc 100. Namely, the record marks are formed such that the 1-bit additional information is recorded into one sync frame, but actually, the 1-bit additional information is recorded into two sync frames. As described above, by performing the BPM modulation on the additional information and then recording it onto the optical disc 100, it is possible to eliminate an influence of the DC component which slightly varies and which is included in the reproduction signal, and it is possible to properly record or reproduce the additional information.

Specifically, if “0” and “1” as the additional information are identified or differentiated, as they are, by using the high or low integrated value, the additional information is influenced by the DC component included in the reproduction signal. Thus, “1” can be detected in a position where “0” as the additional information is to be originally detected, and “0” can be detected in a position where “1” as the additional information is to be originally detected. However, in the optical disc 100 in the first embodiment, since the additional information is BPM-modulated and recorded, it is possible to identity or differentiate “0” and “1” as the additional information, on the basis of the difference in the continuous two bits.

For example, it is assumed that the integrated value of “01” (i.e. such an integrated value that the level is transit from a low value to a high value) is obtained by integrating the reproduction signal. In this case, a difference between the former bit “0” and the latter bit “1” (i.e. the bit on the latter side − the bit on the former side) is “+1”. Moreover, if such an integrated value is obtained that the level is transit from a low value to a high level regardless of the influence by the change in the DC component, the difference is a positive value. In any case, it is possible to identify or differentiate that the recorded additional information is “138 .

On the other hand, it is assumed that the integrated value of “10” (i.e. such an integrated value that the level is transit from a high value to a low value) is obtained by integrating the reproduction signal. In this case, a difference between the former bit “1” and the latter bit “0” is “−1”. Moreover, if such an integrated value is obtained that the level is transit from a high value to a low level regardless of the influence by the change in the DC component, the difference is a negative value. In any case, it is possible to identify or differentiate that the recorded additional information is “0”.

As described above, by identifying or differentiating “0” and “1” of the additional information on the basis of the difference between the continuous two integrated values (i.e. the difference between the integrated value corresponding to the sync frame on the former side and the integrated value corresponding to the sync frame on the latter side), it is possible to record or reproduce the additional information, stably and highly accurately, regardless of the influence by the change in the DC component.

Of course, even without such phase encoding, and even if it is constructed such that the integrated value indicates the additional information as it is, as shown in FIG. 4, obviously, it is possible to properly record or reproduce the additional information.

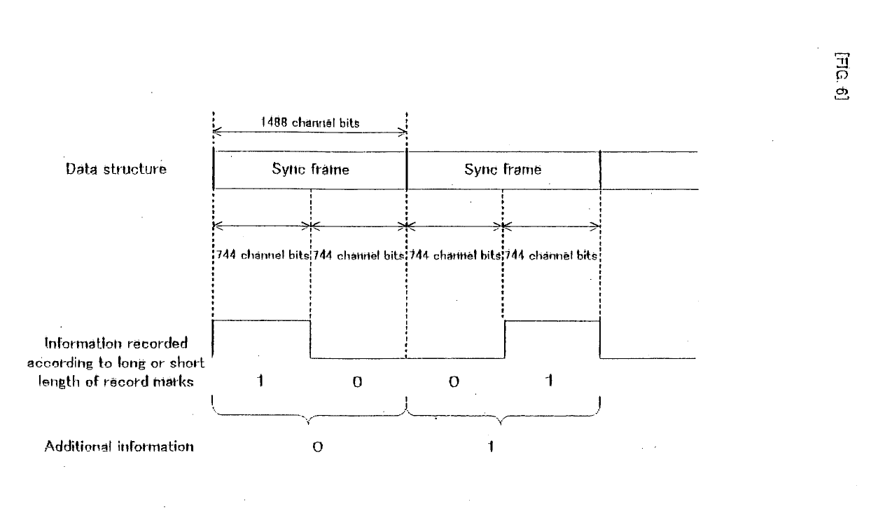

As shown in FIG. 6, the 1-bit additional information may be recorded into one sync frame by recording 2-bit information into the one sync frame. Namely, the additional information may be recorded by increasing or reducing the average length of the record marks, for each data corresponding to a data amount of 744 channel bits. In this aspect of the recording, it is possible to record the additional information with a data amount almost twice 20 as much as the aspect of the recording shown in FIG. 5.

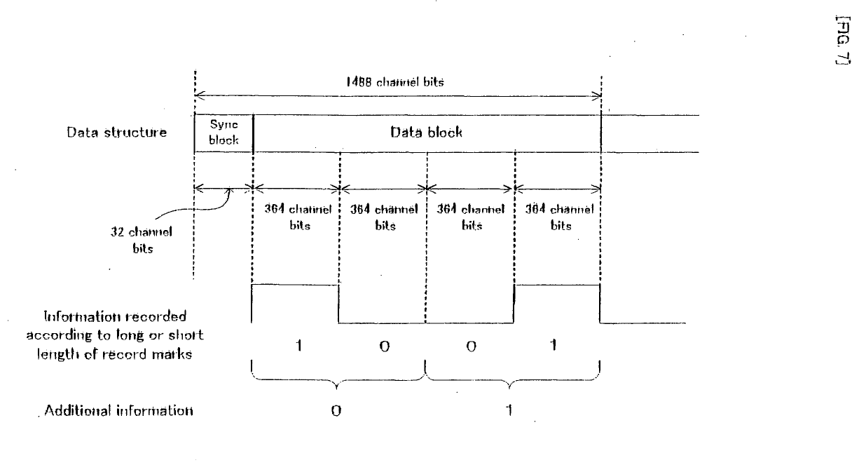

As shown in FIG. 7, the 2-bit additional information may be recorded into one sync frame by recording 4-bit information into the one sync frame. Namely, the additional information may be recorded by increasing or reducing the average length of the record marks, for each data corresponding to a data amount of 364 channel bits. In this aspect of the recording, it is possible to record the additional information with a data amount almost four times as much as the aspect of the recording shown in FIG. 5.

Incidentally, as shown in FIG. 7, the information according to the long or short average length of the record marks may not be recorded in the sync block. Even if it is constructed in this manner, it is possible to properly record the additional information by recording the information according to the long or short average length of the record marks in the data block. Moreover, even in the above-mentioned other aspects of the recording, it may be constructed such that the information according to the long or short length of the record marks is not recorded in the sync block.

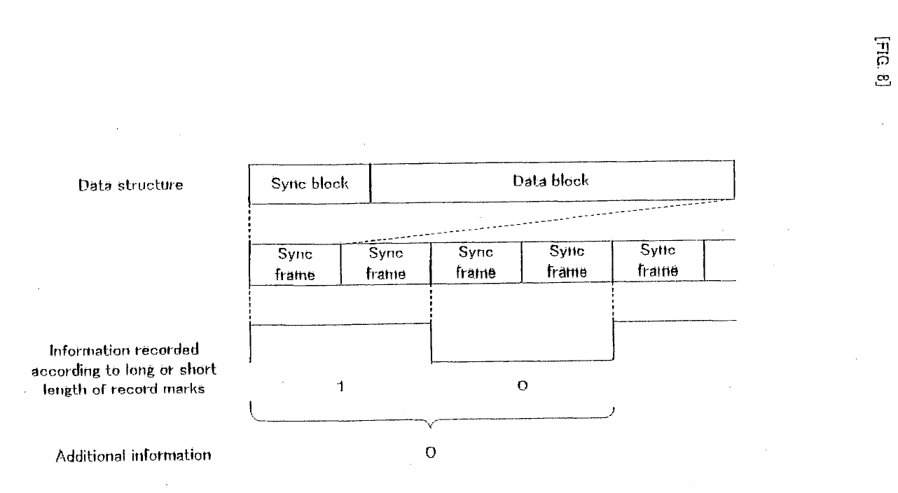

As shown in FIG. 8, the 1-bit additional information may be recorded into four sync frames by recording 1-bit information into the two sync frames. In this aspect of the recording, it is possible to record the additional information with a data amount almost half as much as the aspect of the recording shown in FIG. 5.

Incidentally, if the additional information is recorded in the manner shown in FIG. 8, the data amount of the additional information which can be recorded on the optical disc 100 is reduced. However, from the viewpoint of stabilization of the integrated value, it is preferable to increase a data unit (or cycle) in which one additional information (i.e. 1-bit additional information) is recorded. Namely, as a section (or period) in which the reproduction signal is integrated to generate the 1-bit additional information is longer, it is possible to eliminate a more influence of the RF component included in the reproduction signal.

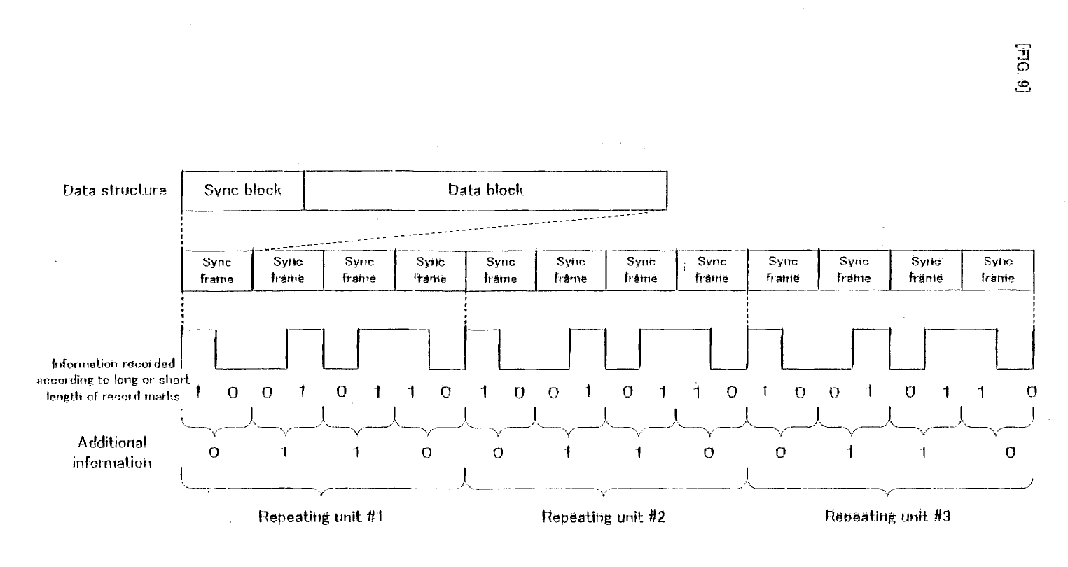

As shown in FIG. 9, certain additional information may be recorded, repeatedly a plurality of times. In FIG. 9, additional information “0110” is recorded by each repeating unit which includes four sync frames for example, and this additional information is recorded, repeatedly three times, in each four sync frames. By virtue of such construction, it is possible to record and reproduce the additional information, more highly accurately. Namely, even in the case where the additional information recorded in a repeating unit #1, for example, cannot be properly reproduced, if the additional information recorded in a repeating unit #2 or a repeating unit #3 can be properly recorded, then, it is possible to generate the additional information. Moreover, by mutually comparing the additional information generated by each repeating unit it is possible to increase reliability of the additional information.

Incidentally, the above-mentioned embodiment is constructed such that the additional information is recorded on the basis of the sync frame, but it is not limited to this. For example, it may be constructed such that the additional information is recorded in each cycle which has no relation to the sync frame, or such that the additional information is recorded by each predetermined address unit.

Moreover, it may be also constructed such that the average length of the record marks are further changed stepwise to be longer or shorter, to thereby record more additional information.

### (2) Second Embodiment

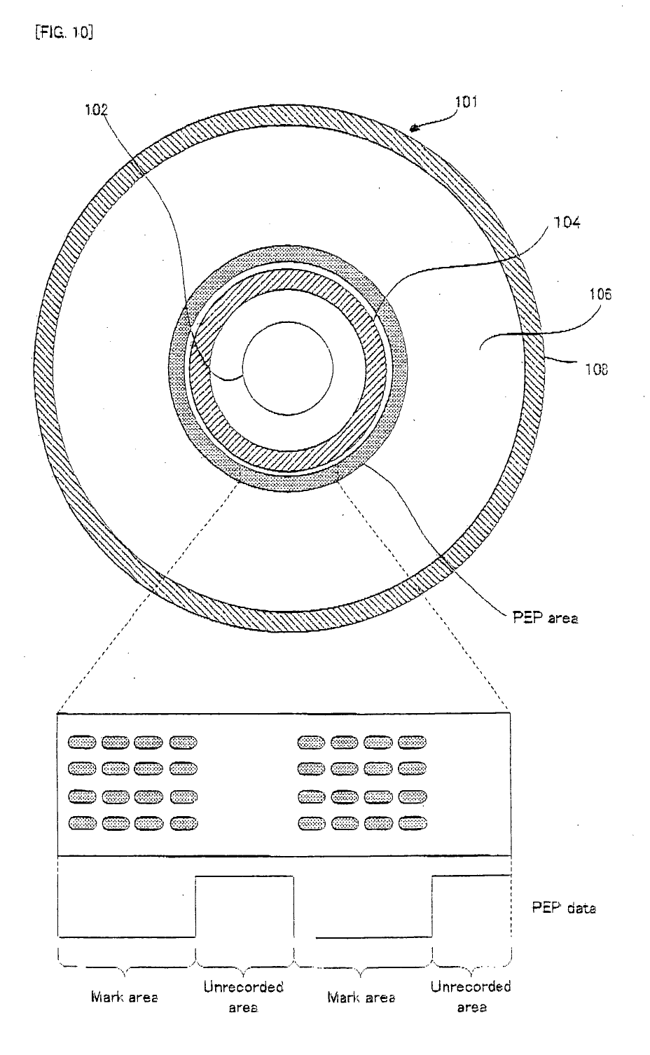

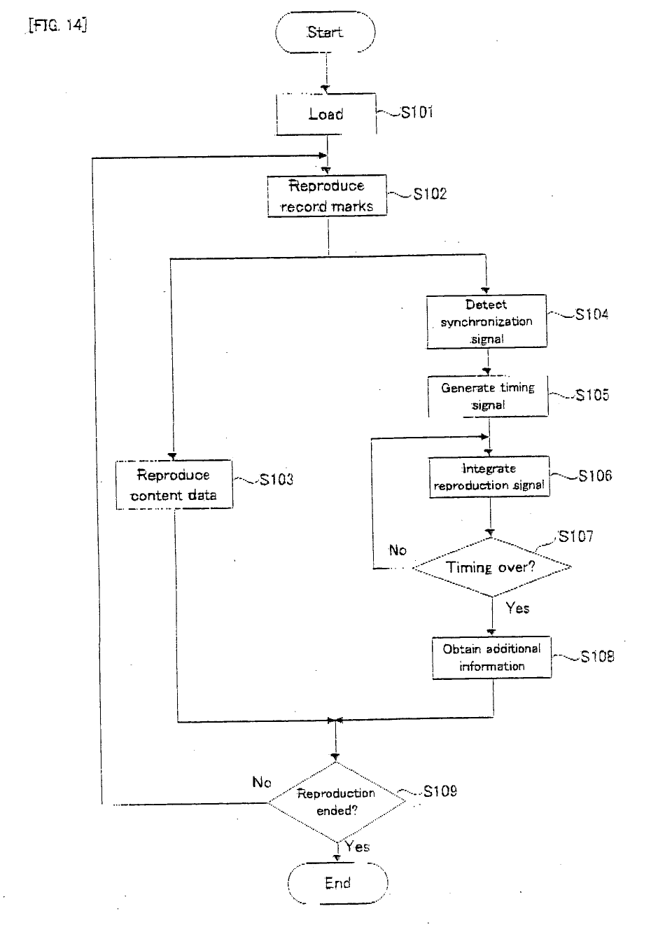

Next, with reference to FIG. 10 to FIG. 12, an optical disc 101 as a second embodiment of the information recording medium of the present invention will be explained. FIG. 14 shows the structure of the optical disc 101 having a plurality of recording areas in a substantial plan view in the upper part, and shows record marks recorded in a PEP (Phase Encoding Part) area of the optical disc 101 in a substantial plan view in the lower part. FIG. 13 and FIG. 14 are data structure diagrams conceptually showing aspects of the recording of the additional information in the second embodiment.

As shown in FIG. 13, the optical disc 101 in the second embodiment has the same data structure as that of the optical disc 100 in the first embodiment. Particularly, the optical disc 101 in the second embodiment has a PEP area as one specific example of the “PEP area” of the present invention, substantially on the inner circumferential side of its recording surface. In this PEP area, there is recorded PEP data as one specific example of the “PEP information” of the present invention. In the PEP data, there is recorded various information indicating the tracking method of the optical disc 101 or the like, for example.

The PEP data is specifically explained by using the lower part of FIG. 10. In the PEP area, there ate a mark area in which the record marks are formed, and an unrecorded area in which the record mark is not formed. For example, the mark area corresponds to the bit “0”, whereas the unrecorded area corresponds to the bit “1”. Then, by combining the mark area and the unrecorded area, as occasion demands (i.e. by combining “0” and “1”, as occasion demands), various information indicating the tracking method or the like, for example, is recorded. In particular, the above-mentioned phase encoding is performed on the PEP data. Namely, the PEP data is recorded (i.e. the mark area and the unrecorded area are formed) such that the information “01” indicates “1” and the information “10” indicates “0”, for example.

Then, in the case where the content data or the like recorded on the optical disc 101 is reproduced by an information reproducing apparatus described later or the like, the PEP data can be obtained by searching the PEP area by using laser light, or the like, for example. Namely, when the reproduction is performed in the PEP area by using the laser light or the like, for example, the reflected light intensity of the laser light is relatively small while the mark area is traced, and the reflected light intensity of the laser light is relatively large while the unrecorded area is traced. By this, it is possible to obtain the PEP data including “0” and “1”, as shown in the lower part of FIG. 10. In particular, it is unnecessary to trace the record track (e.g. the land track and the groove track) disposed on the optical disc 100, and if the PEP area is searched (i.e. by tracing it by using the laser light, or the like), it is possible to obtain the various information indicating the tracking method or the like, relatively easily.

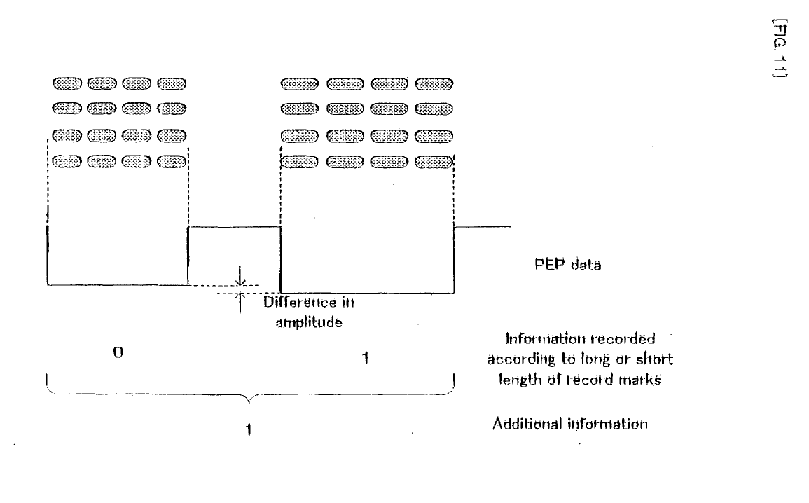

In the second embodiment, the additional information is further recorded by increasing or reducing the average length of the record marks formed in the mark area. Specifically, as shown in FIG. 11, by increasing or reducing, in each mark area, the average length of the record marks formed in the mark area of the PEP area it is possible to record the additional information, as described above.

For example, in FIG. 11, the average length of the record marks in the mark area on the left, of FIG. 11 is relatively short, whereas the average length of the record marks in the mark area on the right of FIG. 11 is relatively long. By reproducing such record marks, it is possible to obtain the reproduction signal of the PEP data, as shown in the lower part of FIG. 11. Specifically, the level of the reproduction signal (or the light intensity of the reflected light) in the mark area in which the average length of the record marks is relatively short, is larger than that of the reproduction signal in the mark area in which the average length of the record marks is relatively long. Therefore, it is possible to identify or differentiate the information “0” and “1” recorded according to the long or short, length of the record marks, on the basis of a difference in the level of the reproduction signal. Then, since the additional information is phase-encoded, it is possible to generate the additional information of “1”. Namely, it is possible to record the 1-bit additional information by using the two mark areas.

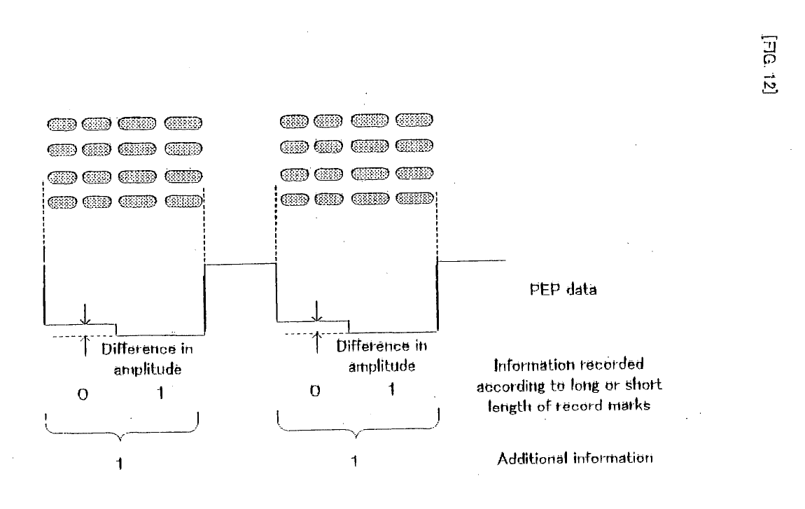

Moreover, as shown in FIG. 12, the additional information can be recorded, as described above, by increasing or reducing the average length of the record marks formed in the mark area of the PEP area, by each predetermined unit in the mark area. For example, in FIG. 12, one mark area is formed from the record marks with the relatively short average length and from the subsequently following record marks with the relatively long average length. Therefore, from the reproduction signal (specifically, the difference in the level of the reproduction signal) in the one mark area, it is possible to generate the information of “0” and “1” recorded according to the long or short length of the record marks, in each mark area. Then, it is possible to generate the additional information of “1” from the mark area. Namely, it is possible to record the 1-bit additional information into each one mark area. In this aspect of the recording, it is possible to record the additional information with a data amount almost twice as much as the aspect of the recording shown in FIG. 11.

Incidentally, even in the case where the average length of the record marks in the PEP area is changed in this manner, it may be constructed such that the 1-bit additional information is recorded by each arbitrary unit, as in the above-mentioned first embodiment.

### Embodiments of Information Reproducing Apparatus

Next, with reference to FIG. 13 to FIG. 17, embodiments of the information reproducing apparatus of the present invention will be explained.

### (1) First Embodiment

Firstly, with reference to FIG. 13 and FIG. 14, a first embodiment of the information reproducing apparatus of the present invention will be explained. FIG. 13 is a block diagram conceptually showing the basic structure of the first embodiment of the information reproducing apparatus of the present invention. FIG. 14 is a flowchart conceptually showing a flow of the entire data reproduction operation of the information reproducing apparatus in the first embodiment.

Incidentally, the information reproducing apparatus in the first embodiment is preferably used mainly in reproducing the information on the above-mentioned information recording medium in the first embodiment.

As shown in FIG. 13, an information reproducing apparatus 1 in the first embodiment is provided with: an optical pickup 301; a spindle motor 302; a RF (Radio Frequency) amplifier 303; a signal reproduction circuit 304; an A/D (Analogue/Digital) converter 305; a synchronization signal detector 306; a timing signal generator 307; an integrator 308; a CPU 309; and a memory 310.

The optical pickup 301 is to perform the recording I reproduction with respect to the optical disc 100, and is provided with a semiconductor laser device, various lenses, an actuator and the like. More specifically, the optical pickup 301 irradiates the optical disc 100 with a light beam, such as laser light LB, with a first power as reading light for reproduction. The optical pickup 301 is constructed to be displaced in the radial direction of the optical disc 100 or the like, by a not-illustrated actuator, slider, or the like driven by the control of a not-illustrated servo circuit or the like.

The spindle motor 302 is constructed to rotate the optical disc 100 at a predetermined speed under spindle servo from a not-illustrated servo circuit or the like.

The RF amplifier 303 amplifies a signal outputted from a not-illustrated PD. (Photo Detector) for receiving reflected light of the laser light LB irradiated from the optical pickup 301, and outputs the amplified signal. Specifically, a RF signal as reproduction signal (or an LPP signal, a wobble signal, or the like) is outputted to the signal reproduction circuit 304.

Incidentally, one specific example of the “reproducing device” of the present invention is constructed by combining the optical pickup 301 and the RF amplifier 303.

The signal reproduction circuit 304 is constructed to perform modulation (e.g. 8/16 modulation) and error correction based on an ECC (Error Correction Code) appended to the reproduction signal, or the like, to the RF signal detected by the RF amplifier 303, to thereby output reproduction data including video data, audio data, data for PC or the like, to the exterior via a buffer and an external output interface, or the like. Then, on external output equipment connected to the external output interface (e.g. a display device, such as a liquid crystal display and a plasma display, a speaker, or the like), predetermined contents are reproduced and outputted.

The A/D converter 305 is constructed to digital convert the RF signal detected by the RF detector 303. Namely, it sampling encodes the RF signal, and output the sampling encoded RE signal to both the synchronization signal detector 306 and the integrator 308. Incidentally, the A/D converter 305 is not necessarily provided, and the reproduction operation explained later may be performed by using an analog signals

The synchronization signal detector 306 is one specific example of the “synchronization signal detecting device” of the present invention, and is constructed to detect a synchronization signal by detecting the sync block provided for each sync frame described above, :from the RF signal outputted from the A/D converter 305. Then, it is constructed to output the detected synchronization signal to the timing signal generator 307.

The timing signal generator 307 is constructed to generate a timing signal indicating timing in which the additional information is reproduced (specifically, the RF signal as the reproduction signal is integrated), on the basis of the synchronization signal outputted from the synchronization signal detector 306.

The integrator 308 is one specific example of the “integrating device” of the present invention, and is constructed to integrate the sampling encoded RF signal. Specifically, the integrator 308 integrates the RF signal by cycle unit indicated by the timing signal, on the basis of the timing signal generated by the timing signal generator 307. Then, as described above, on the basis of the integrated value, the information reproducing apparatus 1 in the first embodiment generates the additional information.

The CPU 309 controls the entire information reproducing apparatus 1, by outputting a system command or the like. Typically, software for operating the CPU 309 is stored in an external memory (e.g. the memory 310).

The memory 310 includes a semiconductor memory, such as a RAM (Random Access Memory) and a flush memory, for example, and is constructed to temporarily record therein the various data required for the operation of the information reproducing apparatus 1.

Next, with reference to FIG. 14, the operation principle of the information reproducing apparatus in the first embodiment will be explained.

As shown in FIG. 14, firstly, the optical disc 100 is loaded (step S101). Then, under the control of the CPU 309, a seek operation is performed by the optical pickup 301, and various management data required for the reproduction process of the data recorded on the optical disc 100 is obtained. On the basis of the management data the data recorded on the optical disc 100 is reproduced, via the external output interface or the like, for example, by the control of the CPU 309.

Specifically, the record marks formed on the optical disc 100 are traced by the laser light LB irradiated from the optical pickup 301, to thereby reproduce the record marks (step S102). Then, the RF signal as the reproduction signal shown in FIG. 3, is detected by the operation of the RF amplifier 303.

Then, by the operation of the signal reproduction circuit 304, the content data, such as the video data, the audio data and the data for PC, is reproduced from the reproduction signal (step S103).

On the other hand, the additional information is reproduced (or generated) from the reproduction signal. Specifically, firstly, the synchronization signal is detected by the operation of the synchronization signal detecting device 306 (step S104). Namely, the synchronization signal is detected by detecting the sync block included in the sync frame, from the RF signal sampling encoded by the A/D converter 305.

Then, by the operation of the timing signal generator 307, the timing signal indicating a reference time point (i.e. a reference cycle) in integrating the RF signal by the integrator 308, is generated from the synchronization signal detected in the step S104 (step S105). For example, in the case where the 1-bit information is recorded in each one sync frame (i.e. where the 1-bit additional information is recorded in each two sync frames) as shown in FIG. 5, the timing signal is generated to perform the integration in each one sync frame (i.e. each 1488 channel bits). Alternatively, in the case where the 2-bit information is recorded in each one sync frame (i.e. where the 1-bit additional information is recorded in each one sync frame) as shown in FIG. 6, the timing signal is generated to perform the integration in each ½ sync frame (i.e. each 744 channel bits). Alternatively, in the case where the 4-bit information is recorded in each one sync frame (i.e. where the 2-bit additional information is recorded in each one sync frame) as shown in FIG. 7, the timing signal is generated to perform the integration in each 364 channel bits. Alternatively, in the case where the 1-bit information is recorded in each two sync frames (i.e. where the 1-bit additional information is recorded in each four sync frames) as shown in FIG. 8, the timing signal is generated to perform the integration in each two sync frames (i.e. each 2976 channel bits).

Then, by the operation of the integrator 308, the RF signal is integrated on the basis of the timing signal generated in the step S105 (step S106). The integration of the RP signal is continued until the predetermined cycle (timing) indicated by the timing signal elapses.

Namely, it is judged whether or not the predetermined cycle (timing) indicated by the ting signal elapses (step S107). If it is judged that the timing does not elapse (the step S107: No), the integration of the RF signal is continued On the other hand, if it is judged that the timing elapses (the step S107: Yes), “0” or “1” is identified or differentiated from the integrated value, under the control of the CPU 309 as one specific example of the “generating device” of the present invention. And the integrated value is reset to “0” under the control of the CPU 309 as one specific example of the “generating device” of the present invention. By integrating the reproduction signal in a plurality of sync frames in a row, it is possible to generate the additional information recorded on the optical disc 100, from the information of “0” or “1” obtained from the integrated value, under the control of the CPU 309 as one specific example of the “generating device” of the present invention (step S108).

Then, under the control of the CPU 309, it is judged whether or not the reproduction operation is ended (step S109). For example, it is judged whether the content data to be reproduced is all reproduced, or whether an instruction to end (or to stop) the reproduction is given from a user of the information reproducing apparatus 1, or the like.

As a result of the judgment, if it is judged that the reproduction operation is not ended (the step S109: No), the reproduction of the record marks is continued, and the content data is reproduced, as occasion demands, to thereby generate the additional information. On the other hand, if it is judged that the reproduction operation is ended (the step S109: Yes), the reproduction operation is ended, and the optical disc 100 is ejected if needed.

Incidentally, in the reproduction operation shown in FIG. 14, the reproduction of the content data and the generation of the additional information are performed simultaneously; however, they may be also separately performed. For example, firstly, only the generation of the additional information may be performed in advance, and then, on the basis of the generated additional information, the content data may be reproduced.

Consequently, according to the information reproducing apparatus 1 in the first embodiment, it is possible to properly reproduce the content data recorded on the information recording medium in the first embodiment described above, and properly generate the additional information.

Incidentally, the above-mentioned information reproducing apparatus 1 in the first embodiment integrates the reproduction signal in accordance with the cycle indicated by the timing signal which is generated on the basis of the synchronization signal. However, even without generating the timing signal, the information reproducing apparatus 1 may integrate the reproduction signal in accordance with the cycle indicated by the synchronization signal. In this case, the timing signal generator 307 is not necessary and it is possible to integrate the reproduction signal, more rapidly,

Moreover, if the additional information is recorded in each predetermined cycle which has no relation to the sync frame, the information reproducing apparatus 1 may be also constructed to generate the timing signal which matches the predetermined cycle. Alternatively, if the additional information is recorded by each address unit, the information reproducing apparatus 1 may be also constructed to generate the timing signal which matches the cycle of the address unit.

### (2) Second Embodiment

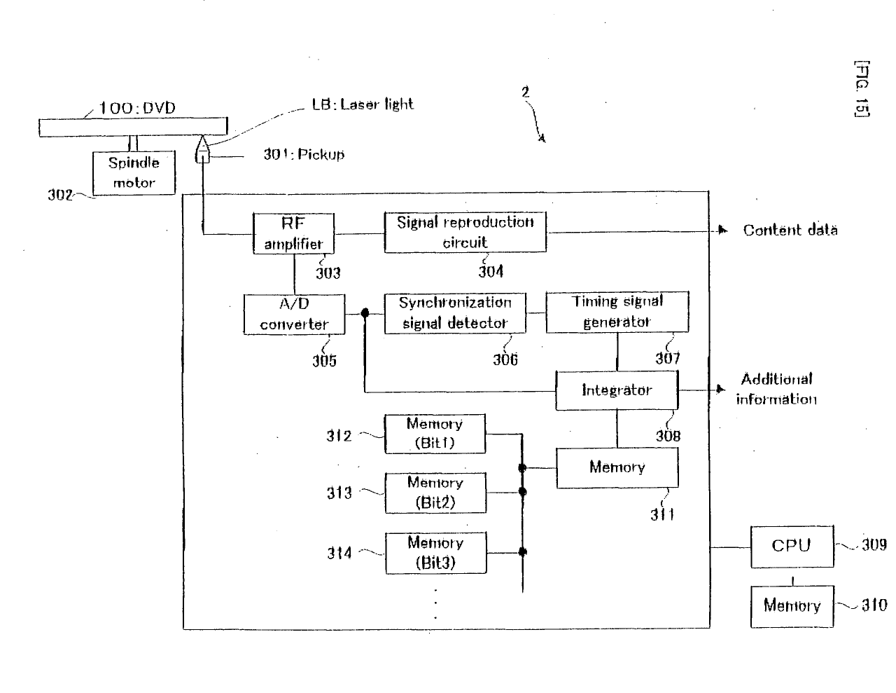

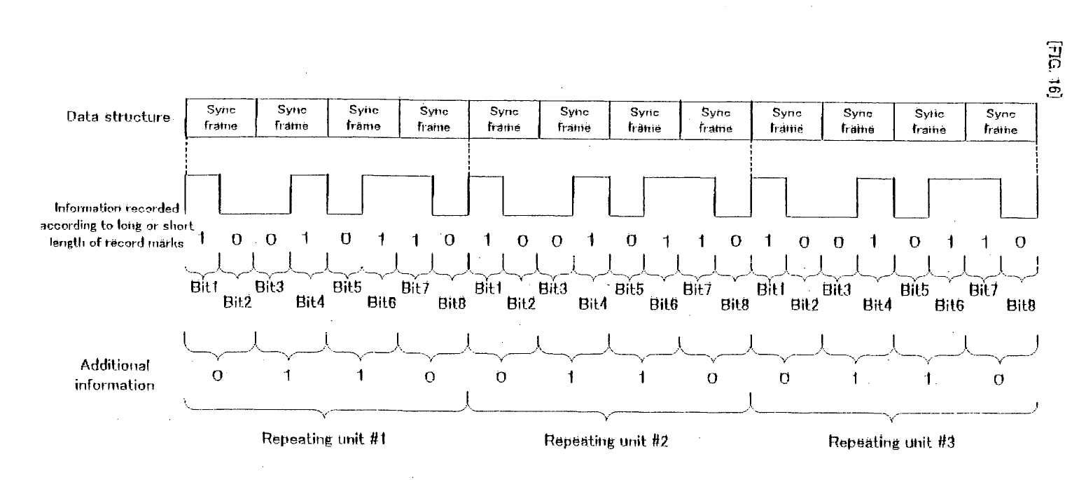

Next, with reference to FIG. 15 and FIG. 16, a second embodiment of the information reproducing apparatus of the present invention will be explained. FIG. 15 is a block diagram conceptually showing the basic structure of the second embodiment of the information reproducing apparatus of the present invention. FIG. 16 is a flowchart conceptually showing a flow of the entire data reproduction operation of the information reproducing apparatus in the second embodiment.

Incidentally, the information reproducing apparatus in the second embodiment is preferably used mainly in reproducing the information on the above-mentioned information recording medium in the first embodiment (particularly, the optical disc shown in FIG. 9).

As shown in FIG. 15, an information reproducing apparatus 2 in the second embodiment is provided with: an optical pickup 301; a spindle motor 302; a RF (Radio Frequency) amplifier 303; a signal reproduction Circuit 304;

an A/D (Analogue/Digital) converter 305; a synchronization signal detector 306; a timing signal generator 307; an integrator 308; a CPU 309; a memory 310; a memory 311; a memory (Bit1) 312; and a memory (Bit2) 313; or the like.

Particularly in the second embodiment, the plurality of memories are provided. The memory 311 includes a semiconductor memory, such as a RA, for example, and is used to store therein the integrated value as an operation result of the integration, while the integration of the RF signal as the reproduction signal is actually performed by the integrator 308, mainly. Moreover, the memory (Bitn (n is an integer of 1 or more)) 311 (312, 313, ) is one specific example of the “storing device” of the present invention, and is used to store the integrated value, with it divided by each predetermined unit (e.g. by each information recorded on the basis of the long or short average length of the record marks).

For example, if a plurality of 4-bit additional information i.e. 8-bit information indicated by the long or short average length of the record marks) is repeatedly recorded, as shown in FIG. 16, there are provided the memory. (Bit1), the memory (Bit2), the memory (Bit3), the memory (Bit4), the memory (Bit5), the memory (Bit6), the memory (Bit7), and the memory (Bit8), in each 8 bits which constitute the additional information.

Then, if the record marks are actually reproduced, the reproduction signal in the record mark portion shown by Bit1 of a repeating unit#1 in FIG. 16 is integrated by using the memory 311, and after the integration of the reproduction signal in the record mark portion shown by Bit1 is ended, the integrated value is recorded into the corresponding memory (i.e. the memory (Bit1)). This operation is repeated for each of the reproduction signals shown by respective Bit1 to Bit 8. Incidentally, at this time, the initial value before the integration operation of each memory is preferably “0”.

Then, after the integration of the reproduction signal in the repeating unit #1 is ended, the reproduction signal in a repeating unit #2 in which the same additional information is recorded is integrated, again. At this time, when the reproduction signal in the record mark portion shown by Bit1 of the repeating unit #1 is integrated, the integrated value for Bit1 of the repeating unit #1, which is recorded in the memory (Bit1), is loaded, and the integrated value corresponding to Bit1 of the repeating unit #2 is added to the loaded integrated value. Then, the added integrated value is recorded again into the memory (Bit1). This operation is repeated from Bit1 to Bit8 of the repeating unit #2, and moreover, repeated from Bit1 to Bit8 of a repeating unit 4#3.

By integrating the reproduction signal in this manner, it is possible to properly generate even the plurality of additional information repeatedly recorded. Namely, by differentiating the integrated value in each data bit and recording it into the memory, it is possible to properly identify the repeating unit, and it is possible to properly generate the desired additional information. In addition, since the plurality of additional information is repeatedly recorded, it is possible to generate (i.e. reproduce) the additional information, highly accurately.

Consequently, according to the information reproducing apparatus 2 in the second embodiment, it is possible to properly reproduce the content data recorded on the information recording medium in the first embodiment described above (particularly, the information recording medium shown in FIG. 9), and properly generate the additional information.

Incidentally, even if the plurality of memories are not physically present, the above-mentioned memory (Bitn (n is an integer of 1 or more)) may be provided by dividing a single memory into a plurality of areas in its internal space, for example. Moreover, after the integration of the repeating units in the plurality of additional information repeatedly recorded are ended, it is preferable to reset the integrated value (i.e. to initialize the memory). Moreover, it may be constructed to reset the integrated value if the added integrated value exceeds a predetermined threshold value, for example. By this, it is possible to effectively prevent memory overflow or the like which can be caused by continuously adding the incorrect integrated value due to a reading error of the additional information, or the like, for example.

### (3) Third Embodiment

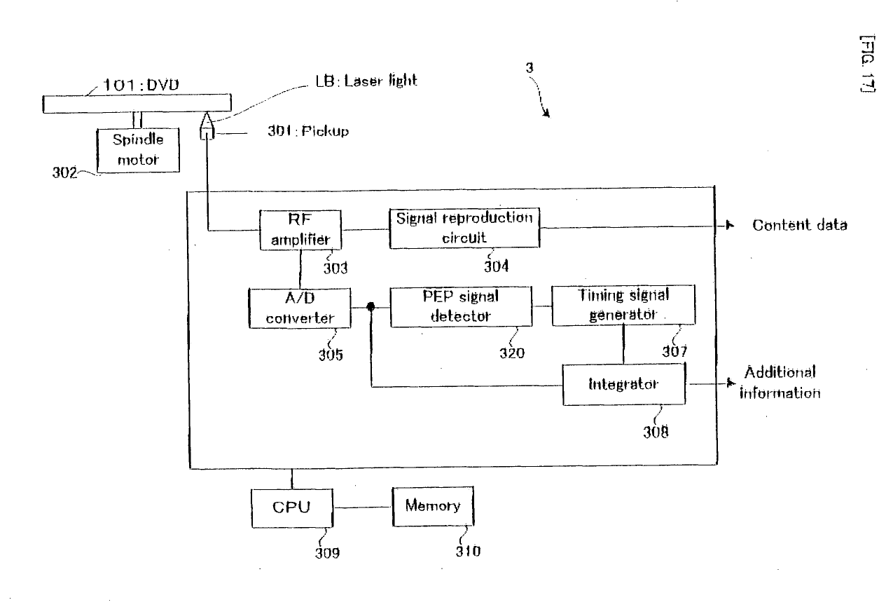

Next, with reference to FIG. 17, a third embodiment of the information reproducing apparatus of the present invention will be explained. FIG. 17 is a block diagram conceptually showing the basic structure of the third embodiment of the information reproducing apparatus of the present invention.

Incidentally, the information reproducing apparatus in the third embodiment is preferably used mainly in reproducing the information on the above-mentioned information recording medium in the second embodiment, as shown in FIG. 17, an information reproducing apparatus 3 in the third embodiment is provided with: an optical pickup 301; a spindle motor 302; a RF (Radio Frequency) amplifier 303; a signal reproduction circuit 304; an A/D (Analogue/Digital) converter 305; a timing signal generator 307; an integrator 308; a CPU 309; a memory 310; and a PEP signal detector 320; or the like.

Particularly in the third embodiment, the PEP signal detector 320 is provided. The PEP detector 320 is constructed to detect the PEP data (or the mark area in which the PEP data is recorded, and the unrecorded area). Specifically, it is constructed to detect a rising pulse (or a rising edge) of the PEP data.

The information reproducing apparatus 3 in the third embodiment, integrates the RF signal as the reproduction signal, which is obtained by reproducing the record marks formed in the mark area, on the basis of the PEP data detected by the PEP detector 320. Specifically, as shown in FIG. 11, if the record marks are formed so as to increase or reduce the average length in each mark area, the timing signal is generated so as to integrate the reproduction signal in each one mark area. Alternatively, as shown in FIG. 12, if the record marks are formed so as to increase or reduce the average length in each half mark area, the timing signal is generated so as to integrate the reproduction signal in each half of the one mark area. Moreover, such a timing signal may be also generated on the basis of a clock signal which is related to a master clock provided for the information reproducing apparatus 3.

Then, the RF signal as the reproduction signal obtained by reproducing the record marks formed in the PEP area is integrated on the basis of the timing signal, and the additional information is generated, as described in the explanation of the information recording medium associated with the embodiment.

Consequently, according to the information reproducing apparatus 3 in the third embodiment, it is possible to properly reproduce the content data recorded on the information recording medium in the second embodiment described above, and properly generate the additional information.

(Information Recording Apparatus)

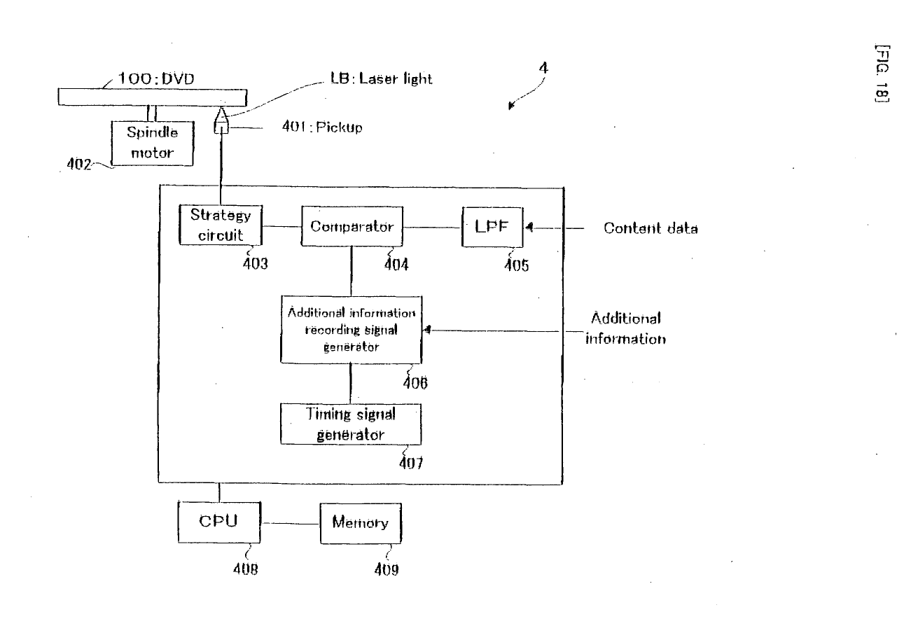

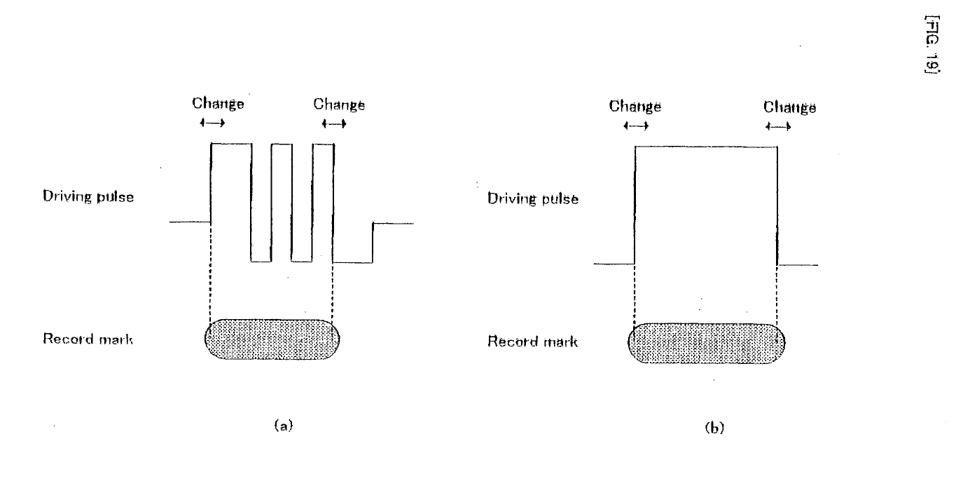

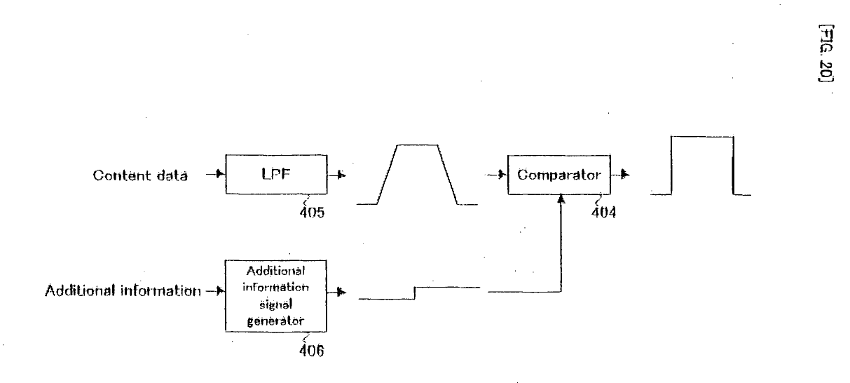

Next, with reference to FIG. 18 to FIG. 20, an explanation will be given for an embodiment of the information recording apparatus of the present invention for recording the content data and the additional information onto the above-mentioned information recording media in the first and second embodiments. FIG. 18 is a block diagram conceptually showing the basic structure of the embodiment of the information recording apparatus of the present invention. FIG. 19 are explanatory diagrams conceptually showing the shape of a driving pulse for irradiating the laser light used in the recording operation. FIG. 20 is an explanatory diagram conceptually showing an aspect of transition of the shape of the driving-pulse used in the recording operation.

As shown in FIG. 18, an information recording apparatus in the embodiment is provided with: an optical pickup 401; a spindle motor 402; a strategy circuit 403; a comparator 404; an LPF (Low Pass Filter) 405; an additional information signal generator 406; a timing signal generator 407; a CPU 408; and a memory 409.

The optical pickup 401 is one specific example of the “recording device” of the present invention. The optical pickup 401 is to perform the recording/reproduction with respect to the optical disc 100 (or 101), and is provided with a semiconductor laser device, various lenses, an actuator and the like. More specifically, the optical pickup 401 irradiates the optical disc 100 with a light beam, such as laser light LB, with a second power as writing light for recording. The optical pickup 401 is constructed to be displaced in the radial direction of the optical disc 100 or the like, by a not-illustrated actuator, slider, or the like driven by the control of a not-illustrated servo circuit or the like. The optical pickup 401 may has the same structure as that of the optical pickup 801 provided for the information reproducing apparatus 1 (2, 3) in the above-mentioned embodiments.

The spindle motor 402 is constructed to rotate the optical disc 100 at a predetermined speed under spindle servo from a not-illustrated servo circuit or the like.

The strategy circuit 403 is constructed to generate a driving pulse for driving the semiconductor laser apparatus included in the optical pickup 401, on the basis of a recording signal outputted from the comparator described later, and to output the driving pulse to the optical pickup 401. Specifically, with respect to the driving pulse defined by an assigned strategy recorded in advance on the optical disc 100, or by a strategy owned in advance or prepared by the information recording apparatus 4, such a driving pulse that the record marks indicated by the recording signal are properly formed is generated.

Now, such a driving pulse that the record marks indicated by the recording signal are properly formed will be explained in more detail, with reference to FIG. 19.

The record marks are formed onto a thermal change type optical disc, such as a DVD-RW, for example, by irradiating with the laser light LB from the optical pickup 401 driven by the driving pulse as shown in FIG. 19(a).

In such a driving pulse, the pulse width of at least one of an start pulse and an end pulse is changed, in order to change the average length of the record marks in each predetermined cycle such that the average length of the record marks is long or short, as described above, on the basis of the recording signal. In particular, it is preferable to change the pulse width, by delaying a time point at which the input of the start pulse is started (i.e. a rising time point of the start pulse), or by expediting a time point at which the input of the end pulse is ended (i.e. a trailing (or falling) time point of the end pulse).

Moreover, the record marks are formed onto a light change type optical disc, such as a DVD-ROM, for example, by irradiating with the laser light LB from the optical pickup 401 driven by the driving pulse as shown in FIG. 19(b).

In such a driving pulse, the pulse width is changed, in order to change the average length of the record marks in each predetermined cycle such that the average length of the record marks is long or short, as described above, on the basis of the recording signal. In particular, it is preferable to change the pulse width, by delaying a rising time point of the driving pulse, or by expediting a trailing time point of the driving pulse.

In FIG. 18 again, the comparator 404 is one specific example of the “additional signal adding device” of the present invention, and is constructed to superimpose or overlap an additional information signal generated by the additional information signal generator 406, onto the recording signal inputted via the LPF 405, and to output it to the strategy circuit 403.

The LPF 405 is one specific example of the “recording signal generating device” of the present invention, and is constructed to remove a high frequency component of the recording signal indicating the content data to be recorded, and then, output the recording signal to the comparator.

Incidentally, the recording signal is generated by performing DVD modulation ( 8/16 modulation) with a not-illustrated DVD modulator or the like, for example, by appending an error correction code with a not-illustrated ECC encoder or the like, for example, and by performing NRZI (Non Return to Zero Inversion) conversion with a not-illustrated NRZI converter or the like, with respect to the content data, for example. Here, the DVD modulator, the ECC encoder, and the NRZI converter can also constitute one specific example of the “recording signal generating device” of the present invention.

The additional information recording signal generator 406 generates an additional information signal indicating the additional information to be recorded onto the optical disc 100 in addition to the normal content data. The additional information signal is generated on the basis of the cycle of the timing signal generated by the timing signal generator 407 described below The tiling signal generator 407 is one specific example of the “synchronization signal generating device” of the present invention, and is constructed to generate a timing signal indicating timing used in reproducing the additional information (specifically, in integrating the RF signal as the reproduction signal), on the basis of the predetermined synchronization signal. On the basis of the timing signal, the additional information signal to be superimposed or overlapped onto the recording signal is generated.

For example, in the case where the 1-bit information is recorded in each one sync frame (i.e. where the 1-bit additional information is recorded in each two sync frames) as shown in FIG. 5, the timing signal is generated to irradiate the laser light LB so as to increase or reduce the average length of the record marks in each one sync frame (i.e. each 1488 channel bits). Alternatively, in the case where the 2-bit information is recorded in each one sync frame (i.e. where the 1-bit additional information is recorded in each one sync frame) as shown in FIG. 6, the timing signal is generated to irradiate the laser light LB so as to increase or reduce the average length of the record marks in each ½ sync frame (i.e. each 744 channel bits). Alternatively, in the case where the 4-bit information is recorded in each one sync frame (i.e. where the 2-bit additional information is recorded in each one sync frame) as shown in FIG. 7, the timing signal is generated to irradiate the laser light LB so as to increase or reduce the average length of the record marks in each 364 channel bits. Alternatively, in the case where the 1-bit information is recorded in each two sync frames (i.e. where the 1-bit additional information is recorded in each four sync frames) as shown in FIG. 8, the timing signal is generated to irradiate the laser light LB so as to increase or reduce the average length of the record marks in each two sync frames (i.e. each 2976 channel bits). At this time, of course, the timing signal may be generated in synchronization with the synchronization signal indicated by the sync block included in each sync frame described above.

The CPU 409 controls the entire information reproducing apparatus 4, by outputting a system command or the like. Typically, software for operating the CPU 409 is stored in an external memory (e.g. the memory 410).

The memory 410 includes a semiconductor memory, such as a RAM (Random Access Memory) and a flush memory, for example, and is constructed to temporarily record therein the various data required for the operation of the information reproducing apparatus 4.

Now, a flow until the recording signal is actually generated will be explained in more detail, with reference to FIG. 20.

As shown in FIG. 20, a pulse for forming the record marks indicating the content data is generated by passing the content data (specifically, the DVD modulated content data or the like, as described above) through the LPF 405. At this time, since it passes through the LPF 405, the edge of the pulse has a certain slope.

On the other hand, with regard to the additional information, by passing it through the additional information signal generator 406 on the basis of the timing signal, the additional information signal which is a pulse having a certain amplitude (or a certain difference in amplitude) is generated.

Then, by comparing the both pulses on the comparator 404, the pulse having a certain slope on the edge is sliced, and the pulse having no slope on the edge for forming the record marks with the different average lengths in accordance with the additional information is generated. On the basis of the pulse, the strategy circuit 403 inputs the predetermined driving pulse to the optical pickup 401, to thereby form the record marks with the different average lengths, as shown in FIG. 4 to FIG. 9 or FIG. 11 and FIG. 12 described above.

Consequently, according to the information recording apparatus, it is possible to properly record the additional information, in addition to recording the normal content data onto the optical disc 100 (101), by increasing or reducing the average length of the record marks in each predetermined cycle.

Incidentally, in the embodiments, the case where the record marks area formed by the irradiation of the laser light LB is explained. However, the same structure can be adopted for a method of forming the record marks which uses a stamp or the like used in manufacturing a DVD-ROM or the like, for example. Namely, if such a stamp that can form the record marks with the long or short average length is manufactured, it is possible to properly prepare the information recording medium in the embodiment by using the stamp. Namely, by using the stamp, it is possible to properly record the content data and the additional information.

Moreover, in the above-mentioned embodiments, the optical disc 100 (or 101) is explained as one example of the information recording medium, the recorder related to the optical disc 100 (or 101) is explained as one example of the information recording apparatus, and the player related to the optical disc 100 (or 101) is explained as one example of the information reproducing apparatus. The present invention, however, is not limited to the optical disc and the recorder and the player thereof, and can be also applied to various information recording media supporting other high-density recording and high transfer rate and the recorder and the player thereof.

The present invention is not limited to the above-described embodiments, and various changes may be made, if desired, without departing from the essence or spirit of the invention which can be read from the claims and the entire specification. An information recording medium, an information recording apparatus, an information recording method, an information reproducing apparatus, an information reproducing method, and a computer program for recording control, which involve such changes, are also intended to be within the technical scope of the present invention.

### Industrial Applicability

The information recording medium, the information reproducing apparatus and method, the information recording apparatus and method, and the computer program of the present invention can be applied to a high-density recording medium, such a DVD, and also applied to a DVD player, a DVD recorder, or the like, for example. Moreover, they can be also applied to an information recording/reproducing apparatus and the like, which are mounted on or which can be connected to various computer equipment for consumer use or for business use, for example.

1-24. (canceled)

25. An information recording medium on which record information is recorded by forming a record mark, wherein
additional information is recorded by changing an average area of the record mark included in each predetermined first cycle, in comparison with a predetermined reference value, and the additional information is phase-modulated and recorded.

26. The information recording medium according to claim 25, wherein
the record information is recorded in synchronization with a synchronization signal which appears in each predetermined second cycle, and
the additional information is recorded, by using the second cycle of the synchronization signal as the first cycle.

27. The information recording medium according to claim 26, wherein the additional information is recorded, by using a cycle of a timing signal which is generated on the basis of the synchronization signal as the first cycle, instead of using the second cycle as the first cycle.

28. The information recording medium according to claim 26, wherein the synchronization signal is a synchronization block which is included in a synchronization frame which is an information unit for recording the record information.

29. The information recording medium according to claim 25, wherein
at least one portion of said information recording medium comprises a PEP area in which PEP information is recorded by combining a mark area in which a plurality of record marks are formed and an unrecorded area in which the record mark is not found, and
the additional information is recorded by changing the average area of the plurality of record marks in the mark area.

30. The information recording medium according to claim 25, wherein the additional information is recorded by changing at least one of an average length and an average width of the record mark in the each predetermined first cycle.

31. The information recording medium according to claim 30, wherein the additional information is recorded by changing at least one of the average length and the average width such that at least one of the average length and the average width becomes long or short.

32. The information recording medium according to claim 25, wherein a plurality of same additional information are repeatedly recorded.

33. An information reproducing apparatus for reproducing the record information recorded on said information recording medium according to claim 25 on which record information is recorded by forming a record mark wherein additional information is recorded by changing an average area of the record mark included in each predetermined first cycle, in comparison with a predetermined reference value, and the additional information is phase-modulated and recorded,
said information reproducing apparatus comprising
a reproducing device for reproducing the record information and obtaining a reproduction signal;
an integrating device for obtaining an integrated value of the reproduction signal in the each first cycle obtained by said reproducing device; and
a generating device for generating the additional information on the basis of the integrated value obtained by said integrating device.

34. The information reproducing apparatus according to claim 33, wherein
the record information is recorded in synchronization with a synchronization signal which appears in each predetermined second cycle,
said information reproducing apparatus further comprises a synchronization signal detecting device for detecting the synchronization signal, and
said integrating device obtains the integrated value, by using the second cycle of the synchronization signal detected by said synchronization signal detecting device as the first cycle.

35. The information reproducing apparatus according to claim 34, wherein said integrating device obtains the integrated value, by using a cycle of a timing signal which is generated on the basis of the synchronization signal detected by said synchronization signal detecting device as the first cycle, instead of using the second cycle as the first cycle,

36. The information reproducing apparatus according to claim 33, wherein said integrating device resets the integrated value in the each first cycle.

37. The information reproducing apparatus according to claim 33, wherein
at least one portion of said information recording medium comprises a PEP area in which PEP information is recorded by combining a mark area in which a plurality of record marks are formed and an unrecorded area in which the record mark is not formed, and the additional information is recorded by changing the average area of the plurality of record marks in the mark area, in comparison with the reference value,
said reproducing device obtains a PEP signal by reproducing the PEP information in the PEP area, and
said integrating device obtains an integrated value of the PEP signal by using a cycle in each which the PEP information is detected as the first cycle, instead of or in addition to obtaining the integrated value of the reproduction signal in the each first cycle.

38. The information reproducing apparatus according to claim 33, wherein
a plurality of same additional information are repeatedly recorded on said information recording medium,
said information reproducing apparatus further comprises a plurality of storing devices, each of which is for adding the integrated value obtained by said integrating device in each of the plurality of same additional information repeatedly recorded and for storing it therein, and
said generating device generates the additional information on the basis of the added integrated value.

39. The information reproducing apparatus according to claim 38, wherein said integrating device resets the added integrated value, in at least one case of a case where the integrated value stored in each of the plurality of storing devices is larger than a predetermined threshold value and a case where a certain time elapses.

40. An information reproducing method of reproducing the record information recorded on said an information recording medium on which record information is recorded by forming a record mark, wherein additional information is recorded by changing an average area of the record mark included in each predetermined first cycle, in comparison with a predetermined reference value, and the additional information is phase-modulated and recorded,
said information reproducing method comprising:
a reproducing process of reproducing the record information and obtaining a reproduction signal;
an integrating process of obtaining an integrated value of the reproduction signal in the each first cycle obtained by said reproducing process; and
a generating process of generating the additional information on the basis of the integrated value obtained by said integrating process.

41. An information recording apparatus for recording record information onto an information recording medium,
said information recording apparatus comprising:
a recording signal generating device for generating a recording signal for forming a record mark onto said information recording medium, on the basis of the record information;
an additional signal adding device for adding an additional signal to the recording signal, the additional signal indicating additional information which is recorded by changing an average area of the record mark in each predetermined first cycle, in comparison with a predetermined reference value; and
a recording device for recording the record information and the additional information by forming the record mark while changing the average area, on the basis of the recording signal to which the additional signal is added, wherein
the additional information is phase-modulated and recorded.

42. The information recording apparatus according to claim 41, wherein
said information recording apparatus further comprises a synchronization signal generating device for generating a synchronization signal which appears in each predetermined second cycle,
said recording signal generating device generates the recording signal for forming the record mark in synchronization with the generated synchronization signal, and
said additional signal adding device adds the additional signal, by using the second cycle as the first cycle.

43. The information recording apparatus according to claim 42, wherein said additional signal adding device adds the additional signal, by using a cycle of a timing signal which is generated on the basis of the synchronization signal as the first cycle.

44. The information recording apparatus according to claim 41, wherein said recording device forms the record mark by irradiating laser light on the basis of a predetermined driving pulse, and irradiates the laser light while changing at least a pulse width of the driving pulse on the basis of the recording signal to which the additional signal is added.

45. An information recording method of recording record information onto an information recording medium,
said information recording method comprising:
a recording signal generating process of generating a recording signal for forming a record mark onto said information recording medium, on the basis of the record information;
an additional signal adding process of adding an additional signal to the recording signal, the additional signal indicating additional information which is recorded by changing an average area of the record mark in each predetermined first cycle, in comparison with a predetermined reference value; and
a recording process of recording the record information and the additional information by forming the record mark while changing the average area, on the basis of the recording signal to which the additional signal is added, wherein
the additional information is phase-modulated and recorded.

46. A computer program product in a computer-readable medium for tangibly embodying a program of instructions executable by a computer provided in an information reproducing apparatus, said computer program product making the computer function as at least one portion of a reproducing device, an integrating device, and a generating device,
said information reproducing apparatus for reproducing the record information recorded on an information recording medium on which record information is recorded by forming a record mark, wherein additional information is recorded by changing an average area of the record mark included in each predetermined first cycle, in comparison with a predetermined reference value, and the additional information is phase-modulated and recorded,
said information reproducing apparatus comprising:
said reproducing device for reproducing the record information and obtaining a reproduction signal
said integrating device for obtaining an integrated value of the reproduction signal in the each first cycle obtained by said reproducing device; and
said generating device for generating the additional information on the basis of the integrated value obtained by said integrating device.

47. A computer program product in a computer-readable medium for tangibly embodying a program of instructions executable by a computer provided in an information recording apparatus, said computer program product making the computer function as at least one portion of a recording signal generating device, an additional signal adding device, and an recording device,
said information recording apparatus for recording record information onto an information recording medium,
said information recording apparatus comprising:
said recording signal generating device for generating a recording signal for forming a record mark onto said information recording medium, on the basis of the record information;
said additional signal adding device for adding an additional signal to the recording signal, the additional signal indicating additional information which is recorded by changing an average area of the record mark in each predetermined first cycle, in comparison with a predetermined reference value; and
said recording device for recording the record information and the additional information by forming the record mark while changing the average area on the basis of the recording signal to which the additional signal is added, wherein
the additional information is phase-modulated and recorded.
